(19) United States
(12) Patent Application Publication
(10) Pub. No.: US 2026/0298439 A1
(43) Pub. Date: Oct. 1, 2026

(54) LIGHTED FLOORING

(71) Applicant: INVENTVEST LLC, ORTONVILLE, MI (US)

(72) Inventors: Jerry Milatz, Traverse City, MI (US); Douglas J. Hamar, Hancock, MI (US)

(21) Appl. No.: 19/635,015

(22) Filed: Mar. 31, 2026

Related U.S. Application Data
(60) Provisional application No. 63/780,930, filed on Mar. 31, 2025.

(51) Int. Cl. F21V 5/04; F21S 8/00; F21V 15/01; F21V 33/00; F21W 131/407

(52) U.S. Cl. CPC F21V 5/04; F21S 8/032; F21V 15/01; F21V 33/006; F21V 33/008; F21W 2131/407

(57) ABSTRACT

A floor assembly is provided that includes a top defining an upper surface and a lower surface. A light source is disposed below the top and includes a light refracting element extending from the lower surface toward the upper surface and terminating between the lower and upper surfaces of the top. The light refracting elements include a plurality of dimples or grooves, or a combination of dimples and grooves. The dimples and grooves have converting smooth sides and terminate at an apex which is below the upper surface of the top.

### CROSS-REFERENCE TO RELATED APPLICATION

This application claims the benefit of US Provisional Application No. 63/780,930 filed March 31, 2025, the entire contents of which is hereby incorporated by reference.

### TECHNICAL FIELD

The present application relates to a light assembly for emitting light through a floor.

### BACKGROUND

Floors or other surfaces can have a variety of designs placed on them depending upon the material used to form the floor or surface. For example, wood floors can have polished finishes, stained finishes, or painted finishes to depict certain designs. One example of this is a sport courts in which lines or other designs are painted onto the wood floor to mark the boundaries of the court and depict other designs, logos, or advertisements.

Some floors are portable and are designed to be able to be removed and reinstalled such as a wood floor for sports courts in sports arenas or other areas. The wood floors are typically placed on a substrate, such as a concrete floor. The wood floor can include a plurality of stringers which are configured to hold the wood floor in a spaced relationship from the wood floor upper or playing surface. The wood floor can be used for events such as basketball or volleyball games. In some embodiments, the floor can be removed for other arena events, such as concerts. Portable floor assemblies are typically made in a series of interconnected floor panels.

In the area of advertising, sporting events represent the pinnacle of impressions and brand exposure. Sporting events provide an atmosphere where every possible surface, that might be visible to a television camera, may be covered with advertising. Historically, these surfaces were static images of corporate logos, or other ad images. Such advertising may be painted on the surface or may be contained on a decal applied to the surface. In the modern era of advertising, many of these surfaces are now digital, and dynamic, allowing multiple ads to be displayed during the event. One example is the LED display mounted to the scorer’s table of a basketball event. The LED displays of this type are contained on a vertical surface and is visible to cameras and patrons that can see the vertical surface.

The floor itself has also been an area of interest for advertisers. However, because the floor is a horizontal surface verses a vertical one, displaying ads on it, presents additional challenges if the advertiser wishes their ad to show well on television as well as being visible to the patrons in the seating area of the sports arena. These challenges include viewing angle, obstructions, and other issues. Additionally, if the advertiser or ad marketer wants to take advantage of digital ads on the floor, brightness also becomes an issue.

Whenever games are played on floors in front of television cameras, the ambient arena light is typically boosted. This bright environment causes all but the brightest video displays to be washed out. A challenge is also presented to allow low viewing angles, rendering an in-floor lighting system which can be a video system, limited in its application

In recent years glass floors have been introduced in which include video capabilities, such as by using LEDs. One such floor is available from ASB Glass Floor and is shown at https://asbglassfloor.com/. ASB Glass Floor offers a full video sports floor made of glass. While such floors are effective for displaying images, they still suffer from some disadvantages.

It would be desirable to provide a floor having video capabilities that more effectively displays the video.

### SUMMARY

In an embodiment, there is provided a floor assembly comprising a top defining an upper surface and a lower surface. A light source disposed below the top. The top comprises a light refracting element extending from the lower surface toward the upper surface and terminating between the lower and upper surfaces of the top.

In an embodiment, there is provided a floor assembly comprising a top defining an upper surface and a lower surface. A light source disposed below the top. The top comprises a light refracting element extending from the upper surface toward the lower surface and terminating between the lower and upper surfaces of the top.

### BRIEF DESCRIPTION OF THE DRAWINGS

FIG. 1 is a top view of a conventional wood floor having a plurality of sections;

FIG. 2 is a perspective view of a floor panel comprising conventional wood slats and a transparent top; and

FIG. 3 is a perspective view partially broken away of an embodiment;

. FIG. 4 is a cross-sectional view of an embodiment;

FIG. 5 is a perspective view partially broken away of an embodiment;

FIG. 6 is a cross-sectional view of an embodiment;

FIG. 7 is a perspective view partially broken away of an embodiment;

FIG. 8 is a cross-sectional view of an embodiment;

FIG. 9 is a bottom view of an embodiment partially broken away;

FIG. 10 is a bottom view of an embodiment partially broken away;

FIG. 11 is a cross-sectional view of an embodiment;

FIG. 12 is a cross-sectional view of an embodiment;

FIG. 13; is a cross-sectional view of an embodiment;

FIG. 14 is an end view partially broken away of an embodiment;

FIG. 15 is a plan view of floor showing an embodiment.

FIG. 16 is a perspective view partially broken away of an embodiment; and

FIG. 17 is a cross-sectional view of an embodiment.

### DETAILED DESCRIPTION

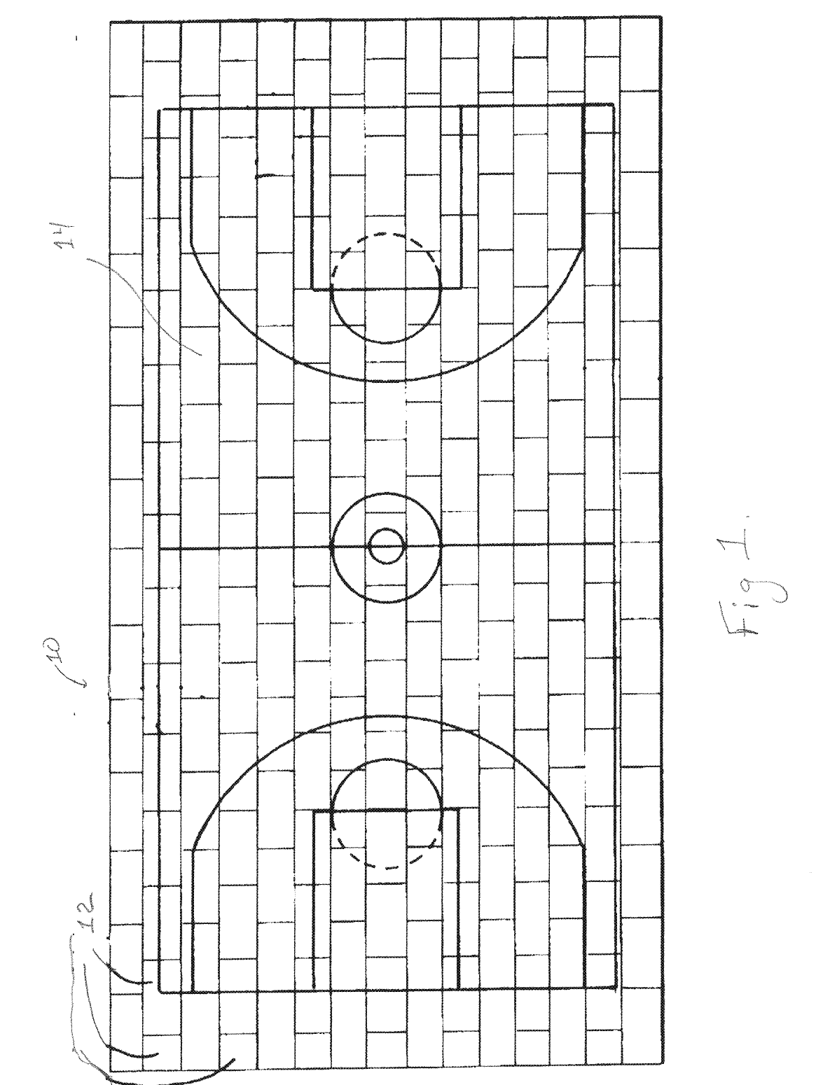

FIG. 1 shows a conventional floor 10 for a sporting event. In an embodiment, the floor 10 comprises wood and is a plurality of sections 12 that may be connectable to provide an entire floor 10. The floor sections 12 in conventional sports flooring may comprise a top surface 14 of wood. One type of top wood surface is presented by a plurality of tongue and groove wood floor boards. It will be appreciated that in other embodiments, the conventional sports flooring may comprise a material other than wood. By way of non-limiting example, the conventional sports flooring may comprise sport court material.

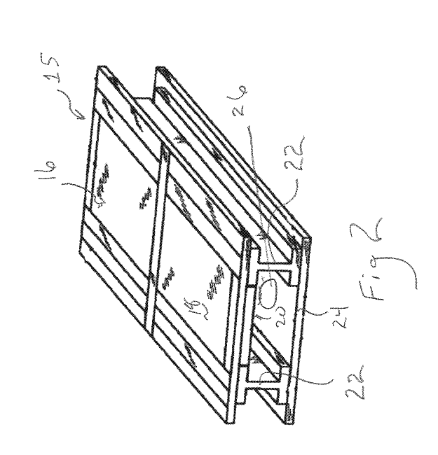

Each floor section 12 may be supported by a plurality of stringers (not shown in FIG. 1, but can be seen in FIG. 2) that are spaced between the top surface and the substrate (not shown) on which the floor is provided. Floors of this type may sometimes be referred to as portable. That is, each floor section 12 can be connected to and disconnected from the next adjacent floor section 12 or sections so the floor 10 can be assembled for use as a sports floor, such as a basketball floor and can be disassembled and moved so other activities can take place that do not require a sports floor.

FIG. 2 shows an embodiment of a floor panel generally indicated at 15 that includes video capability. In this embodiment the floor panel 15 includes top generally indicated at 16 that has a thickness. The top 16 extends between an upper surface 18 and a lower surface 20. The top 16 may be transparent. As with conventional floors, multiple floor panels 15 may be connected to form a sports floor. Such an embodiment may be referred to as a glass floor. It will be appreciated that in a glass floor, the top 16 may be glass, by way of non-limiting example, tempered glass or safety glass. The top may also comprise different materials, such as plastic tops or composite tops that are transparent. Further, the top may comprise one or more than one piece. In an embodiment, the top incudes a protective layer. When the floor panels 15 are connected tops 16 are configured to comprise a continuous upper surface 18 that can be used to perform an activity thereon, such as basketball. The floor panel 15 may also include a light source, schematically shown at 26, below the lower surface 20 of the top 16. The panels 15 may also be disconnected to remove them and to dissemble the floor or sections of the floor. This allows the floor to be portable. Also, FIG. 2 shows a plurality of supports or stringers 22 that are used to support the top 16. A substrate 24 is also shown, upon which the stringers 22 are supported. It will be appreciated that the substrate 24 can comprise many different material and have different configurations which are known. Further, the substrate 24 may be part of the floor panel 15 or may a independent of the floor panel 15.

In an embodiment, the light source 26 may comprise a plurality of light emitting diodes (LED’s). In an embodiment the light source 26 may comprise a plurality organic light emitting diodes (OLED). In an embodiment the light source 26 may comprise a liquid crystal display (LCD). In an embodiment, the light source 26 may comprise a plurality of quantum light emitting diodes (QLED). Such light sources 26 may comprise a display. It will be appreciated that any suitable light source may be used. In some embodiments, the light source 26 may further include back lighting (not shown) which may aid in the brightness of the light source 26. It will further be appreciated that some floor panels 15 may have one type of light source 26 or may have multiple types of light sources 26. In other embodiments, different floor panels 15 may comprise or include different types of light sources 26. By way of non-limiting example, a single floor panel 15 may have one type of light source 26 or it may have different types of light sources 26 in different sections of the panel 15. Further by way of non-limiting example adjacent floor panels 15 may have the same type of light sources 26 or may have different types of light sources 26. The light sources 26 may be arranged so that they can be illuminated to produce different colors as is well-known.

In an embodiment, the light source 26 may be located below the lower or bottom surface 20 of the top 16. Light from the light source 26, which may comprise a display, may be emitted through the top 16. The light sources 26 may be coupled with electronics (not shown) that control the light source in such a way as to produce an image which may be displayed through the top. The image may be static or it may be dynamic. The light source 26 may be disposed in a cavity 25 located below the lower surface 20 of the top 16. The cavity 25 may further be bounded by the substrate 24. As shown in FIG. 3, the cavity 25 may further be bounded by a bottom 27. The top 16 may be supported above the bottom 26, within which the display, or light source 26 may be contained. In this way, a gap 31 may be provided which may accommodate flexing of the top 16 without interference with the display or light source 26.

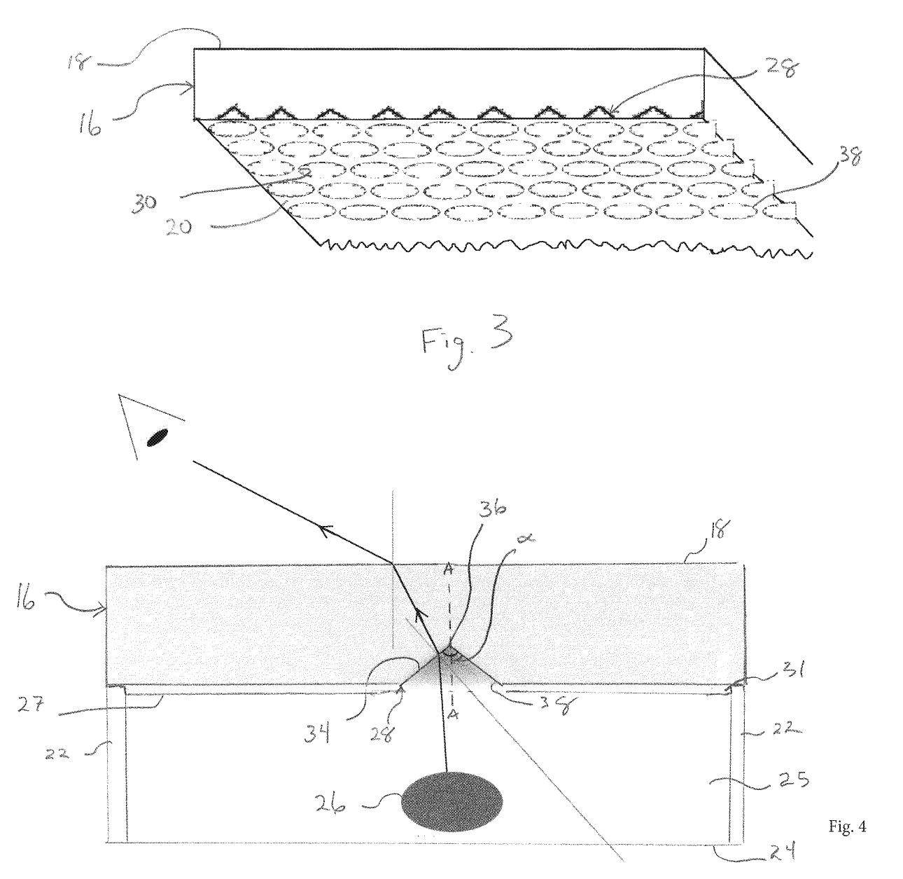

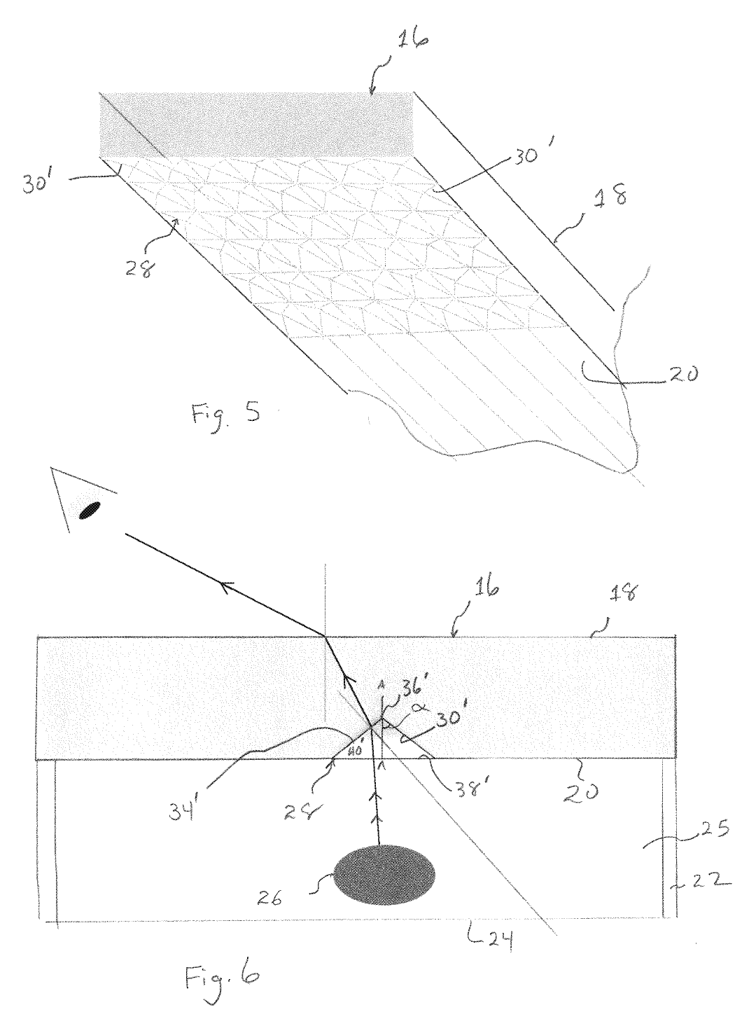

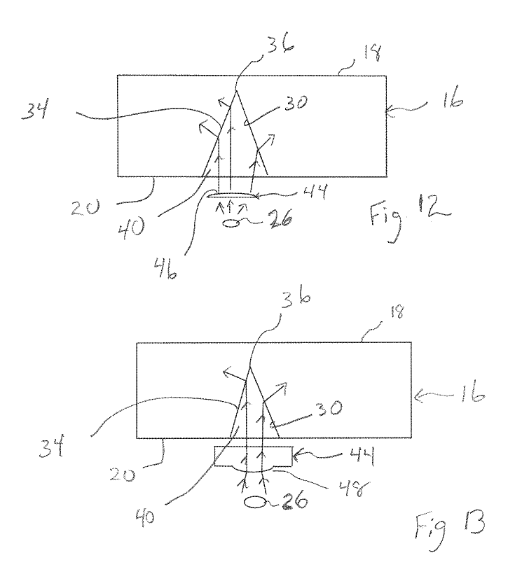

As best seen in FIGS. 3-8 and 11, the top 16 may further comprise a light refracting element generally indicated at 28 extending from the lower surface 20 toward the upper surface 18 and terminating between the lower 20 and upper 18 surfaces of the top 16. In embodiments, the light refracting element may comprise a dimple 30, FIGS. 3-4, 30’, FIGS. 5-6, a channel 32, or a combination of dimples 30, 30’ and channels 32. As best seen in FIGS. 4 and 6, the dimples 30, 30’ may have straight sides 34 34’and converge to a vortex which may define a sharp peak 36, 36’. In an embodiment the dimple 30, 30’ defines an open end 38, 38’ at the lower surface of the top 16. The dimple 30, 30’extends upwardly from the open end 38, 38’toward the upper surface 18 of the top 16. The interior 40, 40’of the dimple 30, 30’, that is the area between the sides or walls 34, 34’, is open and free of the material that comprises the top 16. The sides 34, 34’ of the dimple 30, 30’ converge to the vortex where a peak 36, 36’ is defined.

The sides 34, 34’ of the dimple may be used to redirect light from the light source 26. This may be desirable to increase the brightness for off axis viewing. In the absence of a dimple 30, 30’, light from the light source is primarily directed through the top 16 and normal to the upper surface 18 of the top 16. This provides relatively brighter light in the direction normal to the upper surface 18, referred to herein as on-axis.

In an embodiment the configuration of the dimple 30, 30’ or the channel 32 including a peak 36, 36’, 36’’ may limit the amount of light passing straight through the top 16 or on-axis. These configurations may be desirable in an arena where seating is around the floor 10 and is not necessarily over the floor 10. In this way, the light from the light source 26 may be brighter in an off axis viewing angle as compared with the light just passing straight through the top 16 or on axis. Increasing the brightness for off axis viewing may be desirable so that viewers in the seating area surrounding the floor 10 may better see any image created by the light source 26. The peak is below the upper surface 18 so that light from the light source 26 will be directed in the off-axis direction. By terminating the dimple 30, 30’ below the upper surface 18 of the top 16, the effect of the dimple 30, 30’ on the integrity of the top may be lessened. It will be appreciated, that the height of the dimple 30, 30’ may be varied but it is preferable that a sharp peak be maintained and be located below the upper surface 18 of the top 16. The dimple 30, 30’ may refract light from the light source 26 in such a way as to increase the brightness in an off-axis direction. The solid portion of the top may also further refract the light to also increase the brightness in an off-axis direction.

As shown in FIGS. 4 and 6, light from the light source 26 is directed into the dimple 30, 30’ as shown by the arrow. As light passes through the dimple 30, 30’ it reaches the dimple walls 34, 34’. The sides, or dimple walls, 34, 34’ which are preferably smooth, redirect the light in an off-axis direction. Further, as the light passes from the upper surface 18 of the top 16 into the air, the light further is refracted also in an off-axis direction.

The side or sides 34, 34’ of the dimple 30, 30’ form an angle α with respect to the central longitudinal axis A-A of the dimple 30, 30’, which may be referred to herein as one half of the vortex angle. In an embodiment, the angle α is between 15 degrees and 45 degrees, inclusive. In another embodiment, the angle α may be between 15 degrees and 30 degrees, inclusive. In yet another embodiment, the angle α may be between 15 degrees and 28 degrees, inclusive. It will be appreciated that the angle α may be adjusted to provide the optimum brightness from the light source 26 in an off-axis direction for a viewer in the arena or a camera.

In some situations, it is possible that the incident light, from the light source 26 may be directed to the sides 34, 34’ of the dimple 30, 30’ at an angle too great to allow it to enter the top 16. In such an event, the light would be reflected to the opposite side 34, 34’ of the dimple 30, 30’ where the angle of incident would be smaller, allowing the light to enter and then pass through the top 16 and then be visible to the viewer.

In an embodiment the dimple 30’ has a pyramid shape, having a square or rectangular cross section as best seen in FIGS. 5-6. Each of the sides or walls 34’ intersect at the vortex and for a peak 36 and form angle α. In another embodiment, the dimple 30 is conical having a single side or wall 34 that is circular cross section and converges to a vertex as best seen in FIGS. 3-4. It will be appreciated that the dimple 30’ may also comprise a pyramid shape but having more than four side walls. By way of non-limiting example, the dimple may have eight sides having an octagonal cross section.

It will be appreciated that the top 16 may contain multiple dimples 30, 30’. The dimples 30, 30’ may be configured in any orientation that is desired. In an embodiment, the dimples 30, 30’ may be placed relatively closely together and, in another embodiment, the dimples 30, 30’ may be spaced relatively farther apart.

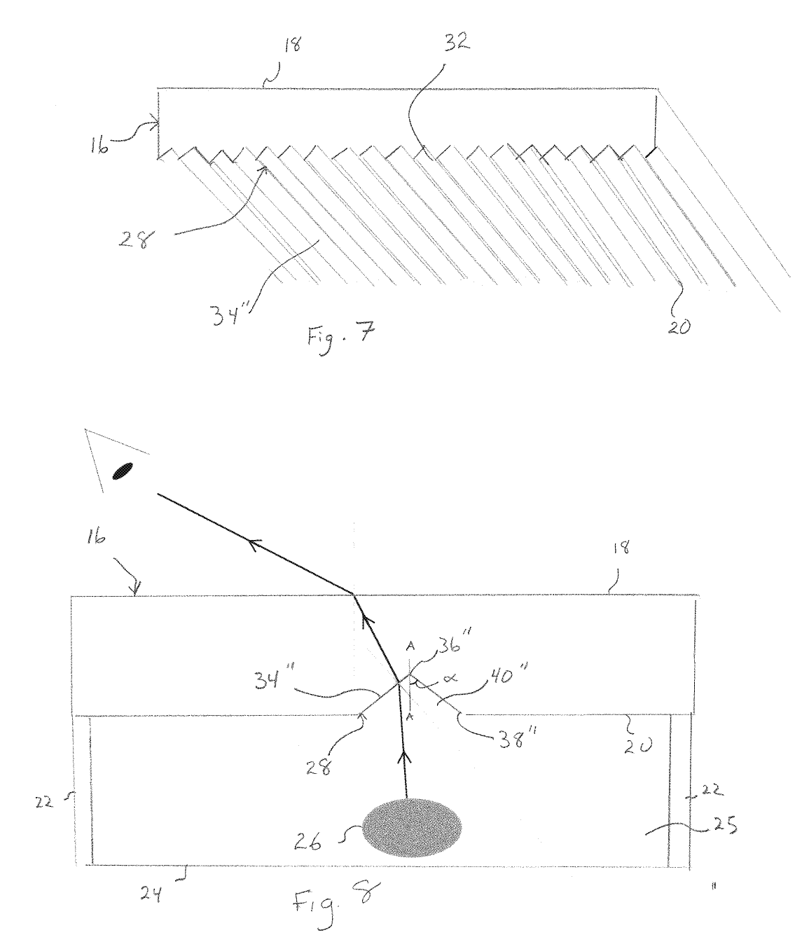

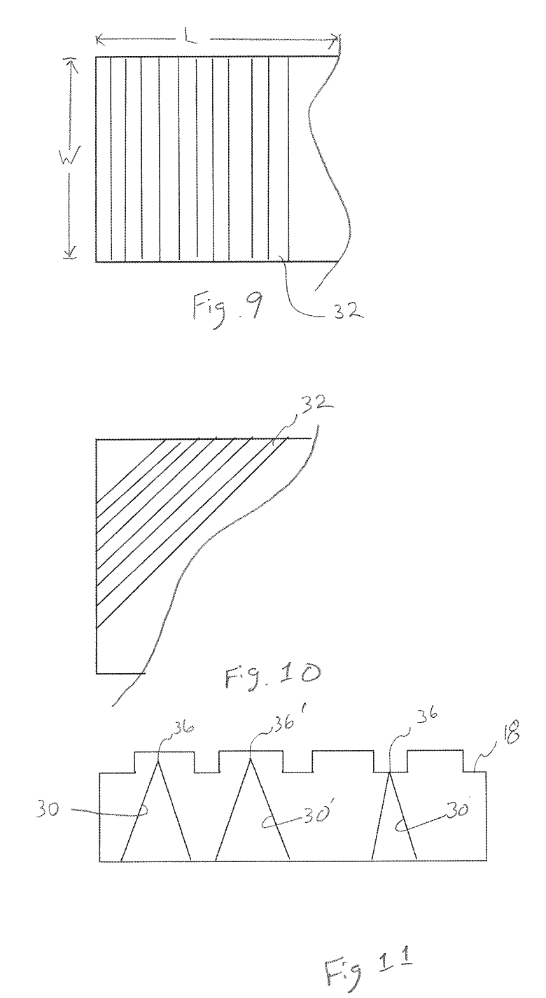

In embodiments, the light refracting element 28 may comprise, a channel.32. As best seen in FIGS. 7-8, the channel 32 may have straight sides 34’’and terminate at a vortex or ridge which may define a sharp peak 36’’. In an embodiment the channel 32 defines an open end 38’’at the lower surface 20 of the top 16. The channel 32, and particularly the sides thereof 34’’ extend upwardly from the open end 38’’ toward the upper surface 18 of the top 16. The channel 32 may also extend up to the length L or width W of the top. FIG. 9 shows the channels 32 extending the width W of the top 16. The channel 32 may also extend at an angle relative to the length or width of the top as best seen in FIG. 10. The interior 40’’ of the channel 32, that is the area between the channel sides 34’’, is open and free of the material that comprises the top 16. The sides 34’’ of the dimple channel 32 converge to the vortex where a peak 36’’ is defined.

The sides 34’’ of the channel 32 may be used to redirect light from the light source 26. This may be desirable to increase the brightness for off axis viewing. In the absence of a channel 32, light from the light source 26 is primarily directed through the top 16 and normal to the upper surface 18 of the top 16. This provides relatively brighter light in the direction normal to the upper surface 18, or on-axis.

In an embodiment the configuration of the channel 32 including a peak 36’’may limit the amount of light passing straight through the top 16 or on-axis. This may be desirable in an arena where seating is around the floor and is not necessarily over the floor. In this way, the light may be brighter in an off axis viewing angle as compared with the light just passing straight through the top which is referred to herein as on axis. Increasing the brightness for off axis viewing may be desirable so that viewers in the seating area surrounding the floor may better see any image created by the light source 26. By terminating the height of the channel 32 below the upper surface 18 of the top 16, the effect of the channel 32 on the integrity of the top 16 may be lessened. It will be appreciated, that the height of the channel may be varied but it is preferable that a sharp peak 36’’ be maintained in embodiments. The channel 32 may refract light in such a way as to increase the brightness in an off-axis direction. The solid portion of the top 16 may also further refract the light to also increase the brightness in an off-axis direction.

The side or sides 34’’of the channel 32 form an angle α with respect to the central longitudinal axis A-A of the channel, which may be referred to herein as one half of the vortex angle. In an embodiment, the angle α is between 15 degrees and 45 degrees, inclusive. In another embodiment, the angle α may be between 15 degrees and 30 degrees, inclusive. In yet another embodiment, the angle α may be between 15 degrees and 28 degrees, inclusive.

In some situations, it is possible that the incident light, from the light source 26 may be directed to the side or wall 34’’ of the channel 32 at an angle too great to allow it to enter the top 16. In such an event, the light would be reflected to the opposite side or wall 34’’ of the channel 32 where the angle of incident would be smaller, allowing the light to enter and pass through the top 16 and then be visible to the viewer.

In an embodiment multiple channels 32 are used. The channels 32 may be arranged to extend in parallel to each other. In other embodiments, the channels may extend transversely to one another. It will be appreciated that any number of channels 32 may be used

It will be appreciated that the top 16 may contain multiple channels 32. The channels may be configured in any orientation that is desired. In an embodiment, the channels may be placed relatively closely together and, in other embodiments, the channels 32 may be spaced relatively farther apart. It will be further appreciated that in other embodiments, the top may include a combination of channels 32 and dimples 30, 30’.

In an embodiment, the upper surface 18 of the top may be textured. By way of example, the upper surface 18 of the top 16 may contain a plurality of buttons 42 which may be cylindrical. The upper surface 18 of the top then comprises has two separate portions. Those with no buttons 42 and those with buttons. 42. In such an embodiment, the dimple 30, 30’ may extend upwardly from the lower surface 20 of the top 16 and into the area defined by the button 42 button where a button 42 is present. The dimple 30, 30’ may also be configured so that the peak 36 is formed below the upper surface 18 of the top 16. It will be appreciated that texturing on the upper surface 18 of the top 16 may comprise any suitable configuration and is not restricted to a button.

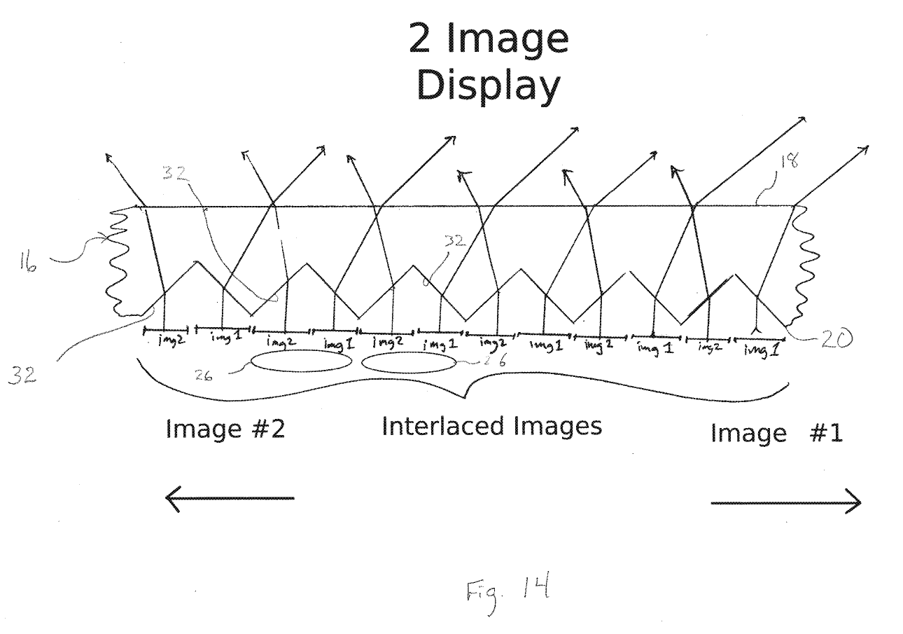

As seen in FIGS. 12-13 in an embodiment, a lens, generally indicated at 44 may be disposed between the light source 26 and the dimple 30. FIGS. 12 and 13 show the lens 44 in connection with a dimple 30. It will be appreciated that the lens 44 may be used in connection with any configuration of a dimple 30, 30’, or may be used in connection with the channel. 32. The lens 44 may be configured to focus or direct the light from the light source 26 to the dimple 30, 30’ or channel 32. In an embodiment, the lens 44 may be convex and dome 46 in the direction of the. dimple30, 30’ or channel 32 as shown in FIG. 13. In an embodiment, the lens 44 may be convex and dome 48 in the direction of the light source 26.

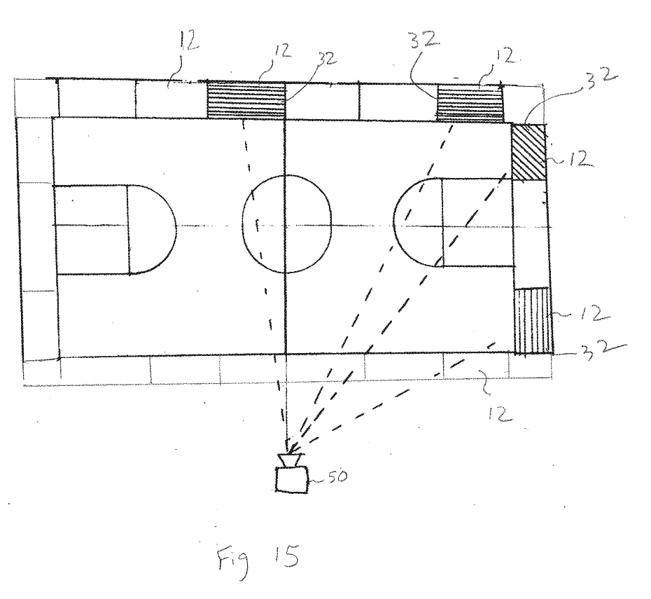

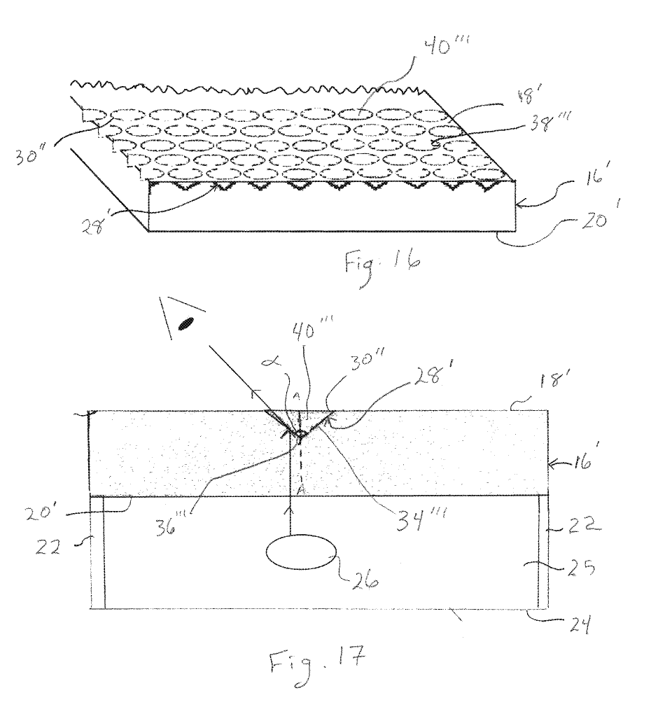

FIG. 14 shows an end view partially broken away of a top 16. Channels 32 are defined by channel sides or walls 34’’extend from the lower surface 20 to the sharp peak 36’’as described above. A light source 26 is disposed below the channel 32. In this embodiment, two images are displayed. One image is displayed to the right, in the direction of the arrows, under Image #1, and a second image is displayed to the left under Image #2. One image will be directed off one of the channel walls 34’’, while the other image will be directed off the other of the channel walls 34” as is shown by the arrows. The two images are interlaced together, in their proper orientation for the side they will be displayed on. By doing this, the audiences to the left and to the right each see their image in the proper orientation. That is, an image displayed to the right will appear right side up to the viewers on the right side, and an image displayed to the left will appear right side up to the viewers on the left side. This embodiment offers that the same image can be displayed in both directions and will appear right side up to the viewers. This embodiment also offers that different images can be displayed in the different directions, and each of the different images will appear right side up to the viewers on the respective side.

FIG. 15 shows a plan view of a sports floor 10. having a plurality of sections 12 (shown outside the playing area) It will be appreciated that the playing surface may also comprise a plurality of sections 12 connected together as set forth above. As shown in FIG. 15 four of the sections or panels 12 include channels 32. The channels 32 in some of the panels extend along the direction of the length of the section 12. Another of the panels 12 has the channels oriented at an angle with respect to the length and with of the panel FIG. 15 also depicts a camera 50. The camera may pivot to pick up images from different areas of view. As shown, the channels 32 may be oriented in a way that they present a more perpendicular orientation with respect to the camera. In this way, enhanced brightness of the image may be achieved from the viewing perspective of the camera 50. It will be appreciated, that the same effect will be had upon a viewer, as well. As shown in FIG. 15, only four sections 12 include the channels. It will be appreciated, that any number of the sections 12 may include the channels. Further, the channels 32 may extend any length and need not necessarily terminate at the edge of a panel. In an embodiment, the channels 32 may be replaced by a plurality of dimples 30, 30’. As with the channels 32, the orientation of a dimple 32’ may be adjusted to allow the light emanating from the tops 16 of the sections 12 to enhance the brightness of the image in a desired direction. It will also be appreciated that the angle α of the sides or walls 34, 34’, 34’’ may be configured to allow the light meaning from the tops 16 of the sections 12 to enhance the brightness of the image in a desired elevation.

FIG. 15 also shows an embodiment of the floor assembly which may comprise a combination of conventional floor panels or sections such as wood panels for the playing surface while the apron area, that adjacent but outside of the playing surface, may contain panels having video capability of the type described above. This may be advantageous in that an image may be displayed on the apron while play is taking place on the playing surface. In such a way, advertisements, messages, or images can be continually displayed such that a viewer can see the advertisements, or so that a camera, such as a television camera, will also see the advertisements, even while play is ongoing.

While the embodiments discussed above have referenced a full floor panel, it will be appreciated that the light source 26 and top 16 may, in other embodiments comprise only a portion of the floor panel. That is, the light source 26 and top 16 may be placed in areas which require illumination while the rest of the floor panel remains conventional. By way of non-limiting example, the floor panel may predominately be made of wood, or other conventional material and segments, such as lines for the boundary may contain the light source and top 16 which may be illuminated. In this way, what would otherwise be floor marking on the playing surface could be lighted, rather than the entire floor 10 being lighted. Further, in an embodiment, a protective layer (not shown) may be placed over the top 16.

The aforementioned embodiments typically include a rigid top 18. It will be appreciated, however that in other embodiments, the dimples 30, 30’ or channels 32 may be formed in a flexible top. The flexible top may be bendable. In an embodiment, the top may comprise a film that may be sufficiently flexible that it may be folded or rolled. In an embodiment, the light source and top may be secured to create a thin light source and top. This arrangement may be folded or rolled and may be unfolded or unrolled and placed on a substrate to provide integrity. In such an embodiment, the substrate comprises the structural integrity needed for the floor to be used, and the light source and top are disposed thereon and may be fastened to the substrate to help fix the light source and top. Further, in an embodiment, a protective layer (not shown) may be placed over the top 16.

Each of the aforementioned embodiments show the dimple or trough extending upwardly from the lower surface toward the upper surface of the top. It will be appreciated that in other embodiments, the dimple or trough can extend downwardly from the upper surface of the top toward the lower surface of the top. As best seen in FIGS. 15 and 17, the top 16’ may further comprise a light refracting element generally indicated at 28’ extending from the upper surface 18’ toward the lower surface 20’ and terminating between the lower 20 and upper 18 surfaces of the top 16. As with the embodiments described above, the light refracting element 28’ may comprise a dimple 30’’, a channel (not shown), or a combination of dimples 30’’ and channels. As best seen in FIG. 17, the dimples 30’’ may have straight sides 34’’’and converge to a vertex which may define a sharp peak 36’’’. In an embodiment each dimple 30’’ defines an open end 38’’’ at the upper surface 18’ of the top 16’. The dimple 30’’extends downwardly from the open end 38’’’ toward the lower surface 20’ of the top 16’. The interior 40’’’of the dimple 30’’, that is the area between the sides or walls 34’’’, is open and free of the material that comprises the top 16’. The sides 34’’’ of the dimple 30’’ converge to the vertex where the peak 36’’’ is defined.

Also, best seen in FIG. 17, a plurality of supports or stringers 22 that are used to support the top 16. A substrate 24 is also shown, upon which the stringers 22 are supported. It will be appreciated that the substrate 24 can comprise many different materials and have different configurations which are known. Further, the substrate 24 may be part of the floor panel 15 or may a independent of the floor panel 15.

As shown in FIG. 17. , light from the light source 26 that is in the direction of the dimple 30’’ is shown by the arrow. As light passes through the dimple 30’’’ it reaches the dimple walls 34’’’. The sides, or dimple walls, 34’’’ which are preferably smooth, redirect the light in an off-axis direction as shown by the arrow.

Each of the angles α of the sides or walls 34’’’ are the same as those set forth in connection with the above embodiments, except that the peak 36’’’ is at the lower end of the converging sides or walls 34’’’.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms "e.g.," “for example,” “by way of non-limiting example,” “for instance,” “such as,” and “like,” and the verbs

“comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A floor assembly comprising:
a top defining an upper surface and a lower surface;
a light source disposed below the top;
wherein the top comprises a light refracting element extending from the lower surface toward the upper surface and terminating between the lower and upper surfaces of the top.

2. A floor assembly as set forth in claim 1 wherein the light refracting element comprises a dimple, said dimple having at least one straight side and the straight sides terminate at a vortex which defines a sharp peak.

3. A floor assembly as set forth in claim 2 wherein the dimple defines a central longitudinal axis, and wherein a side is at an angle with respect to the longitudinal axis.

4. A floor assembly as set forth in claim 3 wherein the angle is between 15 degrees and 45 degrees.

5. A floor assembly as set forth in claim 3 wherein the angle is between 15 degrees and 30 degrees.

6. A floor assembly as set forth in claim 3 wherein the apex angle is between 15 degrees and 28 degrees.

7. A floor assembly as set forth in claim 3 wherein the dimple comprises a pyramid defined by four walls terminating at the vortex.

8. A floor assembly as set forth in claim 3 wherein the dimple comprises a cone defined by a wall terminating at the apex.

9. A floor assembly as set forth in claim 1 wherein the light refracting element comprises a channel having straight sides and terminating at ridge which defines a sharp peak.

10. A floor assembly as set forth in claim 9 wherein the channel defines a central longitudinal axis, and wherein at side is at an angle with respect to the longitudinal axis.

11. A floor assembly as set forth in claim 9 wherein the angle is between 15 degrees and 45 degrees.

12. A floor assembly as set forth in claim 9 wherein the angle is between 15 degrees and 30 degrees.

13. A floor assembly as set forth in claim 8 wherein the angle is between 15 degrees and 28 degrees.

14. A floor assembly as set forth in claim 2 the light source is at least one of an LED, OLED, QLED, or LCD display.

15. A floor assembly as set forth in claim 14 wherein the upper surface of the top is textured.

16. A floor assembly as set forth in claim 14 wherein a protective panel is positioned over the top.

17. A floor assembly comprising:
a top defining an upper surface and a lower surface;
a light source disposed below the top;
wherein the top comprises a light refracting element extending from the upper surface toward the lower surface and terminating between the lower and upper surfaces of the top.

18. A floor assembly as set forth in claim 17 wherein the light refracting element comprises a dimple, said dimple having at least one straight side and the straight sides terminate at a vertex which defines a sharp peak.

19. A floor assembly as set forth in claim 18 wherein the dimple defines a central longitudinal axis, and wherein a side is at an angle with respect to the longitudinal axis.

20. A floor assembly as set forth in claim 19 wherein the angle is between 15 degrees and 45 degrees.
